(19) United States
(12) Patent Application Publication
(10) Pub. No.: US 2009/0144619 A1
(43) Pub. Date: Jun. 4, 2009

(54) METHOD TO PROTECT SENSITIVE DATA FIELDS STORED IN ELECTRONIC DOCUMENTS

(76) Inventors: Steven Francis Best, Georgetown, TX (US); Robert James Eggers, JR., Austin, TX (US); Janice Marie Girouard, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(21) Appl. No.: 11/949,099

(22) Filed: Dec. 3, 2007

(51) Int. Cl. G06F 17/00

(52) U.S. Cl. 715/277

(57) ABSTRACT

A computer implemented method, computer program product and data processing system control the presentation of sensitive data within a document. A request to open a document having redacted sensitive data is received. Responsive to receiving the request to open the document, a reference to sensitive data is identified within the document. The reference points to a separate location than that of the document itself. Responsive to identifying the reference to sensitive data within the document, an attempt to resolve the reference to the separate location is made. If the reference to the separate location cannot be resolved, the document is displayed without the redacted sensitive data.

### BACKGROUND OF THE INVENTION

1. Field of the Invention

The present invention relates generally to an improved data processing system, and in particular to a computer implemented method and apparatus for managing information. Still more particularly, the present invention relates to a computer implemented method, apparatus, and computer usable program product for controlling the presentation of sensitive data within a document.

2. Description of the Related Art

Documents, recordings, or other forms of media containing sensitive data may be viewed and stored on a user's computing device or on a network server. Sensitive data is information that is private, personal, or otherwise unsuitable for dissemination to the public. For example, sensitive data may include trade secrets, user account information, credit card numbers, credit reports, or any other similar type of information.

Sensitive data is often times needed for tracking purposes or to complete online or other transactions. However, after the transaction is completed, the information often remains on the server or within the records even though no further need for the records exists.

Sensitive data may be viewed in public areas, such as in a coffee shop, a waiting room, an airport, or on an airplane. In some instances, the viewing of sensitive data is subject to strict company policies or procedures that are ignored because of time constraints, a blatant disregard for procedures, or inattentiveness. Consequently, sensitive data may be inadvertently disseminated to people having malicious intentions. For example, corporate trade secrets may be obtained by competitors, user's identity may be stolen, or embarrassing details of a user's personal life may be discovered.

Currently used methods for protecting the display of sensitive data include implementing physical components or devices. For example, privacy screens are sometimes applied to laptop monitors or other mobile devices to prevent a third party from viewing information displayed on a laptop monitor. These privacy screens allow only the user sitting directly in front of the laptop to view the presented information. This method, however, does not prevent third parties from viewing the sensitive data if the user steps away from the laptop. Further, use of the privacy screen may give the user a false sense of security, thereby decreasing the user's vigilance against potentially malicious behavior.

Another currently used method for restricting access to sensitive data is to limit the display of information based upon a location of the user. Thus, if the user is in a trusted location, such as the user's office, then the user may access the sensitive content. However, this may be an insufficient means of protection. For example, if a user is at the office, a trusted location, but is negotiating a contract with third parties, then sensitive content may still be presented despite the fact that the user is in a trusted location. Furthermore, this method of restricting the presentation of sensitive data may deny a user the ability to receive certain information without exception, even if the receipt of sensitive data is preferred, necessary, or advantageous.

Thus, the currently used methods for limiting the display of sensitive data may not offer sufficient protection against the inadvertent display of sensitive data. Therefore, it would be advantageous to have a method and apparatus to overcome the problems described above.

### SUMMARY OF THE INVENTION

The illustrative embodiments provide a computer implemented method, computer program product, and data processing system for controlling the presentation of sensitive data within a document. A request to open a document having redacted sensitive data is received. Responsive to receiving the request to open the document, a determination is made as to whether a reference to sensitive data is present within the document. The reference points to a separate location other than that of the document itself. Responsive to determining that a reference to sensitive data is present within the document, an attempt to resolve the reference to the separate location is made. If the reference to the separate location cannot be resolved, the document is displayed without the redacted sensitive data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of data flow between components in accordance with an illustrative embodiment;

FIG. 4 is a series of illustrative screenshots of an exemplary document illustrating the marking of selected data as sensitive in accordance with an illustrative embodiment;

FIG. 5 is a flowchart of a software process for entering sensitive data into a document in accordance with an illustrative embodiment; and

FIG. 6 is a flowchart of a software process for displaying documents containing sensitive data in accordance with an illustrative embodiment.

### DETAILED DESCRIPTION OF THE PREFERRED EMBODIMENT

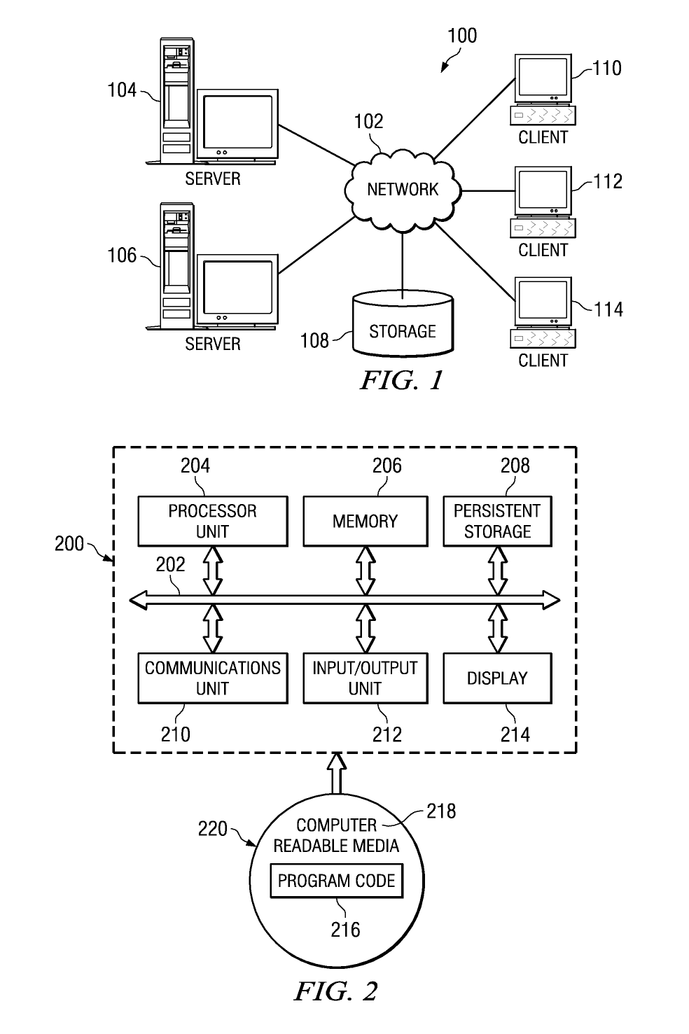

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, client 110, personal digital assistant (PDA) 112, and laptop 114 connect to network 102. Client 110 may be, for example, personal computers or network computers. In the depicted example, server 104 provides data, such as boot files, operating system images, and applications to client 110, personal digital assistant (PDA) 112, and laptop 114. Client 110, personal digital assistant (PDA) 112, and laptop 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

Turning now to FIG. 2, a diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments described herein provide a computer implemented method, apparatus, and computer usable program product for controlling the presentation of information. Responsive to entering data into a document, a user can designate the data as sensitive data. Sensitive data is then abstracted to a separate location, and a reference is inserted into the document. Upon a subsequent viewing of the document, a determination is made as to whether the reference can be resolved to the separate location. Responsive to resolving the reference to the separate location, sensitive data is displayed within the document. Responsive to not resolving the reference to the separate location, sensitive data is not displayed within the document. When sensitive data is not displayed within the document, the user is presented with an edited document that contains only the data that was not designated as sensitive.

Using the method and apparatus described herein, a user is equipped with improved access control over data fields in a document. Sensitive personal data contained within various documents throughout a file system can be effectively purged of sensitive personal data without the need to individually examine, or delete separate documents. The user is provided with greater control of the entry of personal data into documents, and the storage of personal data therein, that have a temporal usefulness.

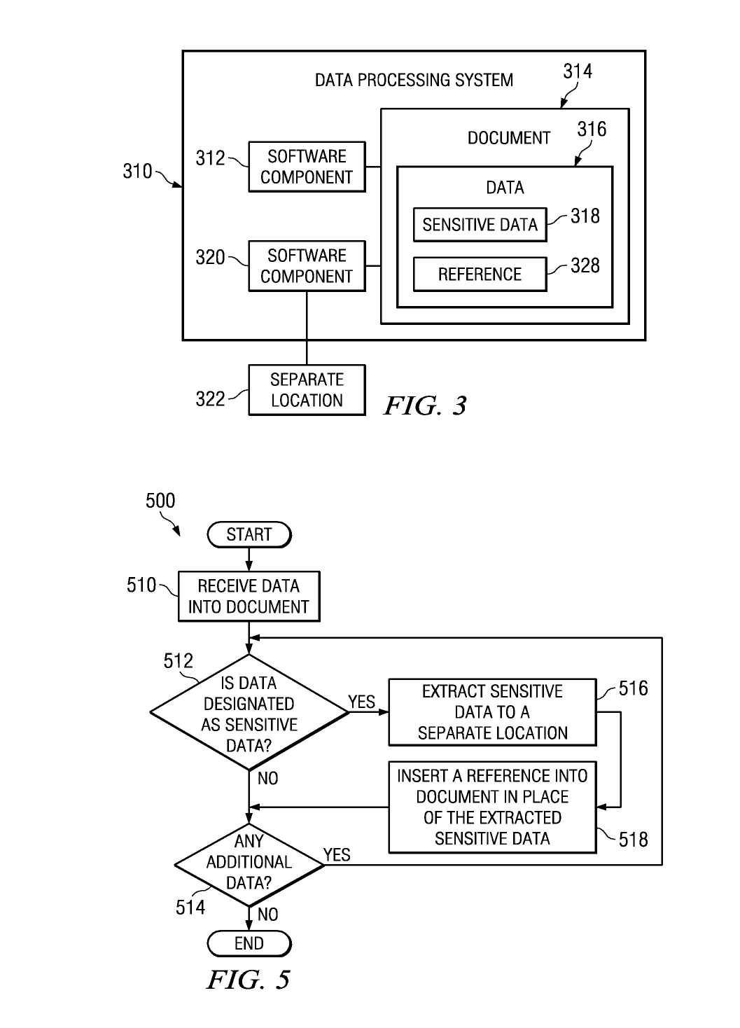

Referring now to FIG. 3, a block diagram of data flow between components is shown in accordance with an illustrative embodiment. Data processing system 310 can be data processing system 200 of FIG. 2.

Software component 312 executes on data processing system 310. Software component 312 is any software capable of creating documents or editing information within a document. Software component 312 can be a spreadsheet program, such as Excel® or Lotus 1-2-3®. Software component 312 can be a word processing program, such as, for example, Word® or Word Perfect®. As another example, software component 312 can also be an email program, such as Outlook® or Eudora®. Word®, Word Perfect®, and Outlook® are trademarks of Microsoft Corporation in the United States, other countries, or both. Lotus 1-2-3® is a trademark of IBM Corporation in the United States, other countries, or both. Eudora® is a trademark of Qualcomm, Inc. in the United States, other countries, or both. Additionally, software component 312 may be implemented as a plug-in component that works with another application capable of creating documents or editing information within a document.

Software component 312 accesses document 314. Document 314 is a computer file that contains data that can be accessed by applications, such as software component 312. Document 314 contains data 316.

Data 316 may be designated as sensitive by the author or recipient of data 316. This designation forms sensitive data 318. For example, if data 316 is a document, spreadsheet, presentation, email, web page, instant message, voice recording, video, or similar form of communication, then the author of the communication may designate a portion of data 316 as sensitive to form sensitive data 318. The portion of data sensitive 318 may be, for example, a paragraph, a slide, a sentence, a word, or a particular message. When using software component 312 to generate document 314, software component 312 may provide the user with a selectable menu option from graphical user interface 320 to designate a portion of data 316 as sensitive data 318. Alternatively, graphical user interface 320 may be operable by a user to designate portions of data 316 as sensitive data 318 when document 314 is created by an ancillary program. Sensitive data 318 can be a portion of data 316. Sensitive data 318 can also be the entirety of data 316.

Sensitive data 318 can be, for example, personal information, including without limitation, bank accounts, social security numbers, driver's license numbers, telephone numbers, e-mail addresses, home addresses, or personal passwords. Sensitive data 318 can similarly be enterprise information, including without limitation, stock information, shareholder minutes, or accounting information.

By choosing to designate a portion of data 316 as sensitive data 318 from graphical user interface 320, data redacting process 322 is initiated. Data redacting process 322 is a software process executing on software component 320. Data redacting process 322 designates data, such as data 316, as sensitive data, such as sensitive data 318.

Responsive to designating sensitive data 318, data redacting process 322 extracts sensitive data 318 from document 314, and transfers sensitive data 318 to separate location 326. Data redacting process 322 is a software process executing on software component 310. Data redacting process 322 removes and saves sensitive data, such as data 318, in a separate location, such as separate location 326.

Data redacting process 322 is capable of receiving a designation that data is sensitive. Data redacting process 322 is further capable of redacting the sensitive data 318 from document 314, and transferring sensitive data 318 to separate location 326. In one illustrative embodiment, data redacting process 322 is a native process to software component 310. Conversely, data redacting process 322 can be implemented in other ways, such as, for example, as a plug-in or other separate applications that works in conjunction with software component 312.

Separate location 326 is a data structure at a memory location that is separate from the location of document 314. Separate location 326 can be a different sector on a physical drive of a common data processing system. Separate location 326 can be a removable storage device, such as a compact disk, a floppy disk, a flash drive, a zip drive, a universal serial bus drive, a solid state drive, or other persistent storage device that can be removed from data processing system 310. Separate location 326 can further be a separate data processing system that is connected via a network, such as network 102 of FIG. 1 to data processing system 310. Separate location 326 can be server 104, server 106 client 110, personal digital assistant 112, and laptop 114 of FIG. 1.

Data redacting process 322 then inserts reference 328 into document 314. Reference 328 is a data type whose value refers to another value, sensitive data 318, stored elsewhere in the computer memory, such as separate location 326, using its address. Reference 328 can be a pointer.

Data resolution process 324 is a software process executing on software component 312. Data resolution process 324 resolves reference 328 to separate location 326, and reinserts sensitive data 318 into document 314.

Data resolution process 324 resolves reference 328 to separate location 326 by examining reference 328. Data resolution process 324 attempts to follow reference 328 to the separate location 326. Data resolution process 324 can resolve reference 328 to separate location so long as data resolution process 324 has access to separate location 326, and can retrieve sensitive data 318 therefrom. For example, if separate location 326 is on a removable storage device, such as a CD ROM or a flash memory device, data resolution process 324 can resolve reference to separate location 326 so long as the removable storage device is inserted into data processing system 310.

So long as data resolution process 324 can resolve reference 328 to separate location 326, sensitive data 318 in document 314 is displayed. That is, if data resolution process 324 can connect to or has access to separate location 326 to which data redacting process 322 extracted and transferred sensitive data 318 then sensitive data 318 will be displayed within document 314.

However, if data resolution process 324 cannot resolve reference 328 to separate location 326, sensitive data 318 in document 314 is not displayed. That is, if data resolution process 324 cannot connect to or does not have access to separate location 326 to which data redacting process 322 extracted and transferred sensitive data 318 then sensitive data 318 will not be displayed within document 314.

In the case where sensitive data 318 will not be displayed within document 314, reference 328 can also include an obscured view of sensitive data 318 in some embodiments. In the different illustrative examples, obscuring sensitive data 318 means displaying an altered appearance of sensitive data 318 so that this data cannot be read. The altered appearance need not be created from the sensitive data, but can simply be a generic image for use in place of the sensitive data. For example, blurring out sensitive data 318 so that it cannot be read is one method of obscuring sensitive data 318. Non-sensitive content may likewise be inserted in place of sensitive data 318. Non-sensitive content may be a statement such as, “sensitive” or “redacted” that is used to replace sensitive data 318. Such a statement indicates that sensitive content exists, but does not divulge the substance or location of sensitive data 318.

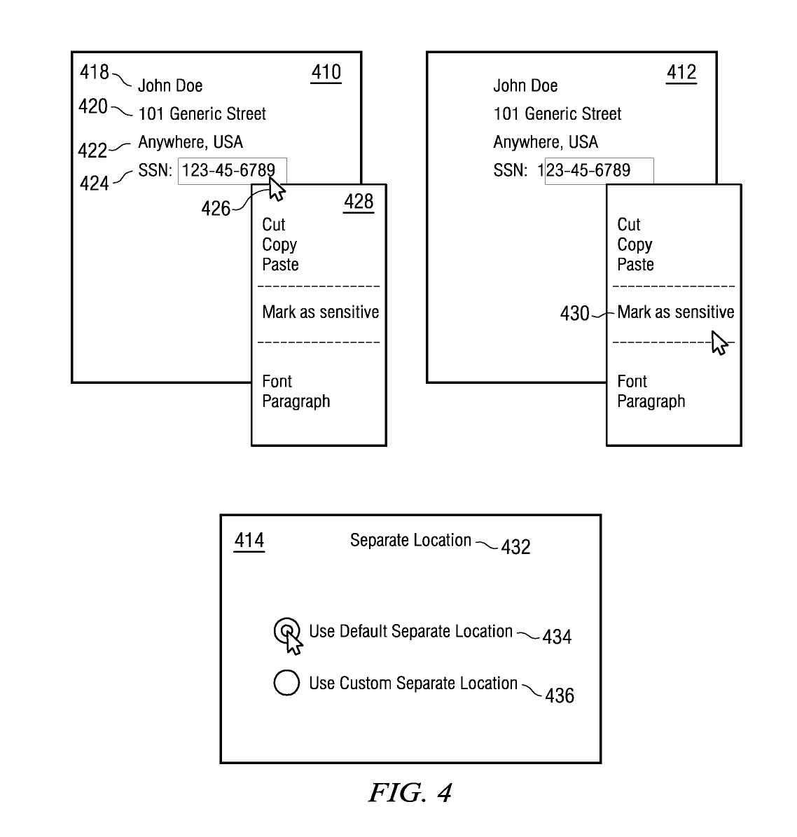

Referring now to FIG. 4, a series of illustrative screenshots of an exemplary document illustrating the marking of selected data as sensitive is depicted in accordance with an illustrative embodiment. The illustrative screenshots 410, 412, and 416 show the marking of data, such as data 316 of FIG. 3, within a document, such as document 314. The data can be marked as sensitive data, such as sensitive data 318 of FIG. 3. Sensitive data is then removed to a separate location, such as separate location 326 of FIG. 3. A reference, such as reference 328 of FIG. 3, is then inserted into the document in place of the removed sensitive data.

Screenshot 410 shows a document having data 418-424. Data 418-424 can be data 316 of FIG. 3. Data 424 has been selected with pointer 426. Responsive to selecting data 424, selectable menu option 428 is displayed. As shown in screenshot 412, mark-as-sensitive selection 430 is selected from selectable menu option 428. Data 424 has now been designated as sensitive data, such as sensitive data 318 of FIG. 3.

Data 424 is designated as sensitive by associating a tag with, or otherwise identifying data 424 as sensitive. A tag is a relevant keyword or term associated with or assigned to data 424 as a whole or only to a part of it, for purposes of keyword-based classification and search of information.

Referring now to screenshot 414, responsive to selecting mark-as-sensitive selection 430, separate location prompt 432 can be presented. Separate location prompt 432 cues the user to input a separate location to which data 424 is to be extracted. A user can then select whether to use a default Separate location, such as, for example, by selecting default-selection 434. A user can similarly select whether to use a custom separate location, such as, for example, by selecting custom-selection 436. Default-selection 434 has been selected in screenshot 414.

Referring now to FIG. 5, a flowchart of a software process for entering sensitive data into a document is depicted in accordance with an illustrative embodiment. Process 500 is a software process, such as data redacting process 322 of FIG. 3, executing on a software component, such as software component 312 of FIG. 3.

Process 500 begins by receiving data into a document (step 510). The document can be document 314 of FIG. 3. The data can be data 316 of FIG. 3. The document can be, without limitation, a spreadsheet, a word pad, an email, a word processing document, presentation, web page, instant message, voice recording, video, or similar form of communication. Data can be any input by a user into the document.

Process 500 then identifies whether the data has been designated as sensitive data (step 512). When using process 500 to generate the document, process 500 may provide the user with a selectable menu option to designate a portion of the data as sensitive data. Alternatively, process 500 may include a graphical user interface operable by a user to designate portions of data as sensitive data when a document, such as document 314 of FIG. 3, is created by an ancillary program. The sensitive data can be sensitive data 318 of FIG. 3, which is the entirety or a portion of data 316 of FIG. 3.

Responsive to not identifying that the data is sensitive data (“no” at step 512), process 500 determines whether any additional data has been entered into the document. (step 514). If additional data has been entered (“yes” at step 514), process 500 returns to step 512 to receive a determination of whether the additional data has been designated as sensitive data. If additional data has not been entered (“no” at step 514), the process terminates.

Returning now to step 512, responsive to identifying that the data is sensitive data (“yes” at step 512), process 500 extracts the sensitive data from the document, and transfers the sensitive data to a separate location (step 516). The separate location can be separate location 322 of FIG. 3. The separate location is a data structure at a memory location that is separate from the location of document. The separate location can be a different sector on a physical drive of a common data processing system. The separate location can be a removable storage device, such as a compact disk, a floppy disk, a flash drive, a zip drive, a universal serial bus drive, a solid state drive, or other persistent storage device that can be removed from the data processing system. The separate location can further be a separate data processing system that is connected via a network, such as network 102 of FIG. 1 to data processing system 310. The separate location can be server 104, server 106 client 110, personal digital assistant 112, and laptop 114 of FIG. 1.

Process 500 then inserts a reference into the document in place of the extracted sensitive data (step 518). The reference is a data type whose value refers to another value stored elsewhere in the computer memory using its address. The reference can be a pointer.

So long as process 500 can resolve the reference to the separate location, the sensitive data in the document is displayed. That is, if the data processing system can connect to or has access to the location to which process 500 has extracted and transferred the sensitive data, the sensitive data will be displayed within the document.

However, if the data processing system cannot resolve the reference to the separate location, the sensitive data in the document is not displayed. That is, if the data processing system cannot connect to or does not have access to the location to which process 500 has extracted and transferred the sensitive data, the sensitive data will not be displayed within the document.

In the case where the sensitive data will not be displayed within the document, the reference can also include an obscured view of sensitive data within the document. In the different illustrative examples, obscuring sensitive data means altering the appearance of the sensitive data so that it cannot be read. For example, blurring out the sensitive data so that it cannot be read is one method of obscuring the sensitive data. Non-sensitive content may likewise be inserted in place of the sensitive data. Non-sensitive content may be a statement such as, “sensitive” or “redacted” that is used to replace the sensitive data. Such a statement indicates that sensitive content exists, but does not divulge the substance or location of sensitive data.

Responsive to inserting a reference into the document in place of the extracted sensitive data, process 500 returns to step 514 to determine whether any additional data has been entered into the document. The process can repeat, until no further information has been designated as sensitive.

Using the illustrative embodiments, a user is equipped with improved access control over data fields in a document. Sensitive personal data contained within various documents throughout a file system can be effectively purged of sensitive personal data without the need to individually examine, or delete separate documents. The user is provided with greater control of the entry of personal data into documents, and the storage of personal data therein, that have a temporal usefulness.

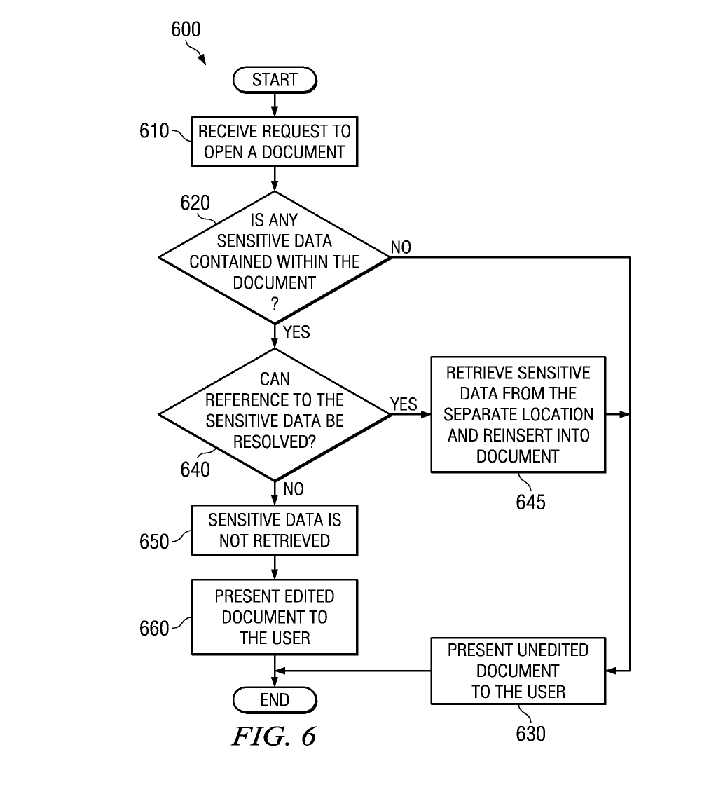

Referring now to FIG. 6, a flowchart is shown of a software process for displaying documents containing sensitive data in accordance with an illustrative embodiment. Process 600 is a software process, such as data resolution process 324, executing on a software component, such as software component 312 of FIG. 3.

Process 600 begins by receiving a request to open a document (step 610). Responsive to receiving a request to open a document, process 600 identifies whether any sensitive data is contained within the document (step 620).

Process 600 can identify the existence of sensitive data within the document by parsing the document for any data that has been designated as sensitive data. Parsing can be done by searching data within the document for a tag, pointer, flag, bit, or other indicator that identifies the sensitive data within the document. Parsing can be done by searching data within the document for the existence of a reference, such as reference 328 of FIG. 3. Alternatively, process 600 can identify a flag or other indicator associated with the document itself without parsing the actual text of the document, to determine whether the document contains sensitive data.

Responsive to process 600 not identifying any sensitive data contained within the document (“no” at step 620), process 600 presents the unedited document to a user (step 630), with the process terminating thereafter. Because no sensitive data is contained within the document, all data contained within the document is presented to, and is viewable by, the user.

Returning now to step 620, responsive to 600 identifying sensitive data contained within the document (“yes” at step 620), process 600 attempts to resolve the reference to the sensitive data at the separate location (step 640). So long as the process 600 can resolve the reference to the separate location, the sensitive data in the document is displayed. That is, if process 600 can connect to or has access to the location at which the sensitive data was extracted and transferred to, the sensitive data will be displayed within the document.

The separate location is a data structure at a memory location that is separate from the location of the document. The separate location can be a different sector on a physical drive of a common data processing system. The separate location can be a removable storage device, such as a compact disk, a floppy disk, a flash drive, a zip drive, a universal serial bus drive, a solid state drive, or other persistent storage device that can be removed from data processing system. The separate location can further be a separate data processing system that is connected via a network, such as network 102 of FIG. 1 to the data processing system. The separate location can be server 104, server 106 client 110, personal digital assistant 112, and laptop 114 of FIG. 1.

Responsive to determining that the reference to the sensitive data at the separate location can be resolved (“yes” at step 640), process 600 retrieves the sensitive data from the separate location and reinserts the sensitive data into the document (step 645). Process 600 then returns to step 630, and presents the unedited document to a user (step 630), with the process terminating thereafter. Because process 600 was able to resolve the reference to the separate location, the sensitive data in the document is displayed.

Sensitive data may be reinserted into the document. Conversely, document may display the contents of the data structure to which the reference's address is resolved. In either embodiment, the user is able to view the document, including the sensitive data therein. The document may appear seamless to the user viewing the document, so that the user is unable to tell that the displayed sensitive data has been redacted from, and reinserted into, the document.

Returning now to step 640, responsive to determining that the reference to the sensitive data at the separate location cannot be resolved (“no” at step 640), process 5600 does not retrieve the sensitive data from the separate location (step 650). The document is left containing only the data that was not designated as sensitive data. Process 600 may display the reference to the sensitive data from the document by displaying a blacked out portion, by displaying a void, or otherwise obscuring sensitive data, or by replacing the sensitive data with non-sensitive content.

Responsive to not retrieving the sensitive data from the separate location, process 600 presents the edited document to a user (step 660), with the process terminating thereafter. Because process 600 was unable to resolve the reference to the separate location, only the data contained within the document that was not identified as sensitive data and abstracted to the separate location is presented to, and is viewable by, the user. The document is left containing only the data that was not designated as sensitive data.

Thus, the illustrative embodiments described herein provide a computer implemented method, apparatus, and computer usable program product for controlling the presentation of information. Responsive to entering data into a document, a user can designate the data as sensitive data. Sensitive data is then abstracted to a separate location, and a reference is inserted into the document. Upon a subsequent viewing of the document, a determination is made as to whether the reference can be resolved to the separate location. Responsive to resolving the reference to the separate location, sensitive data is displayed within the document. Responsive to not resolving the reference to the separate location, sensitive data is not displayed within the document. When sensitive data is not displayed within the document, the user is presented with an edited document that contains only the data that was not designated as sensitive.

Using the method and apparatus described herein, a user is equipped with improved access control over data fields in a document. Sensitive personal data contained within various documents throughout a file system can be effectively stored at a second secure location, such that appropriation of secured documents will not result in the compromising of sensitive data. The user is provided with greater control of the entry of personal data into documents, and the storage of personal data therein, that have a temporal usefulness.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling the presentation of sensitive data within a document, the method comprising:
receiving a request to open a document having sensitive data that has been redacted from the document,
responsive to receiving the request to open the document, identifying a reference to sensitive data within the document, wherein the reference is a reference to a separate location;
responsive to identifying the reference to sensitive data within the document, determining whether the reference can be resolved; and
responsive to a determination that the reference cannot be resolved, displaying the document without the sensitive data.

2. The computer implemented method of claim 1, further comprising:
responsive to a determination that the reference can be resolved, displaying the document with the sensitive data.

3. The computer implemented method of claim 1, wherein the step of identifying the reference to sensitive data within the document comprises:
identifying a flag associated with the document.

4. The computer implemented method of claim 1, wherein the step of identifying the reference to sensitive data within the document comprises:
parsing the document for a tag, a pointer, a flag, or a bit associated with text of the document to identify whether the document contains sensitive data.

5. The computer implemented method of claim 1, wherein the separate location is selected from the group consisting of: a compact disk, a floppy disk, a flash drive, a zip drive, a universal serial bus drive, or a solid state drive.

6. The computer implemented method of claim 1, wherein the document having sensitive data is stored on a first data processing system, and wherein the separate location is a second data processing system.

7. The computer implemented method of claim 1, wherein the step of displaying the document without the sensitive data comprises:
at least one of displaying the document with a blacked out image of the sensitive data,
displaying an obscured image of the sensitive data,
displaying a blurred out view of the sensitive data, and
displaying a non-sensitive content replacement of the sensitive data.

8. A computer program product comprising:
a computer readable medium having computer usable program code for transferring data between virtual partitions, the computer program product comprising:
computer usable program code for receiving a request to open a document having sensitive data that has been redacted from the document,
computer usable program code, responsive to receiving the request to open the document, for identifying a reference to the sensitive data within the document, wherein the reference is a reference to a separate location;
computer usable program code, responsive to identifying the reference to the sensitive data within the document, for determining whether the reference can be resolved; and
computer usable program code, responsive to a determination that the reference cannot be resolved, for displaying the document without the sensitive data.

9. The computer program product of claim 8 further comprising:
computer usable program code, responsive to a determination that the reference can be resolved, for displaying the document with the sensitive data.

10. The computer program product of claim 8 wherein the computer program code for identifying the reference to sensitive data within the document comprises:
identifying a flag associated with the document.

11. The computer program product of claim 8, wherein the computer usable program code for identifying the reference to sensitive data within the document comprises:
parsing the document for a tag, a pointer, a flag, or a bit associated with text of the document to identify whether the document contains sensitive data.

12. The computer program product of claim 8, wherein the separate location is selected from the group consisting of: a compact disk, a floppy disk, a flash drive, a zip drive, a universal serial bus drive, or a solid state drive.

13. The computer program product of claim 8, wherein the document having sensitive data is stored on a first data processing system, and wherein the separate location is a second data processing system.

14. The computer program product of claim 8, wherein the computer usable program code for displaying the document without the sensitive data comprises:
at least one of computer usable program code for displaying the document with a blacked out image of the sensitive data,
computer usable program code for displaying the document with an obscured image of the sensitive data,
computer usable program code for displaying the document with a blurred out view of the sensitive data, and
computer usable program code for displaying the document with a non-sensitive content replacement of the sensitive data.

15. A data processing system comprising:
a bus;
a communications unit connected to the bus;
a storage device connected to the bus, wherein the storage device stores computer usable program code; and
a processor unit connected to the bus, wherein the processor unit executes the computer usable program code to receive a request to open a document having sensitive data that has been redacted from the document, responsive to receiving the request to open the document, to identify a reference to the sensitive data within the document, wherein the reference is a reference to a separate location, responsive to identifying the reference to sensitive data within the document, to determine whether the reference can be resolved, and responsive to a determination that the reference cannot be resolved, to display the document without the redacted sensitive data.

16. The data processing system of claim 15, wherein the processor unit executes the computer usable program code responsive to a determination that the reference can be resolved, to display the document with the redacted sensitive data.

17. The data processing system of claim 15, wherein the program code to identify the reference to sensitive data within the document comprises:
program code to parse the document for a tag, a pointer, a flag, or a bit associated with text of the document to identify whether the document contains sensitive data.

18. The data processing system of claim 15, wherein the separate location is selected from the group consisting of:
a compact disk, a floppy disk, a flash drive, a zip drive,
a universal serial bus drive, or a solid state drive.

19. The data processing system of claim 15, wherein the document having redacted sensitive data is stored on a first data processing system, and wherein the separate location is a second data processing system.

20. The data processing system of claim 15, wherein the program code to display the document without the redacted sensitive data comprises:
at least one of program code to display the document with a blacked out image of the sensitive data,
program code to display an obscured image of the sensitive data, program code to display a blurred out view of the sensitive data, and
program code to display a non-sensitive content replacement of the sensitive data.
